(19) United States
(12) Patent Application Publication
(10) Pub. No.: US 2020/0098134 A1
(43) Pub. Date: Mar. 26, 2020

(54) IMAGING SYSTEM, IMAGING DEVICE AND SIGNAL PROCESSOR

(71) Applicant: AISIN SEIKI KABUSHIKI KAISHA, Kariya-shi (JP)

(72) Inventors: Shingo Fujimoto, Tokai-shi (JP); Osamu Uno, Kasuya-gun (JP); Satoshi Mori, Kasuya-gun (JP); Takuro Oshida, Anjo-shi (JP)

(73) Assignee: AISIN SEIKI KABUSHIKI KAISHA, Kariya-shi (JP)

(21) Appl. No.: 16/567,283

(22) Filed: Sep. 11, 2019

(30) Foreign Application Priority Data
Sep. 26, 2018 (JP) 2018-180965

(51) Int. Cl. G06T 7/73; H04N 13/296; H04N 5/33

(52) U.S. Cl. CPC G06T 7/73; H04N 13/296; G06T 2207/10048; G06T 2207/10024; G06T 2207/10028; H04N 5/33

(57) ABSTRACT

An imaging system includes an imaging device and a signal processer, the imaging device including a cache memory and an imaging controller which acquires an infrared image of a subject and depth information indicating a distance from the imaging device to the subject, the imaging controller transmitting the infrared image to the signal processor and storing the depth information at the cache memory, the signal processer including a signal processing control portion which receives the infrared image from the imaging device, detects a two-dimensional coordinate of a predetermined position on the infrared image transmitted from the imaging device, acquires the depth information for the detected two-dimensional coordinate from the cache memory, generates a three-dimensional coordinate of the predetermined position within a three-dimensional space based on the two-dimensional coordinate and the acquired depth information, and outputs a control signal to an external device based on the three-dimensional coordinate.

### CROSS REFERENCE TO RELATED APPLICATIONS

This application is based on and claims priority under 35 U.S.C. § 119 to Japanese Patent Application 2018-180965, filed on Sep. 26, 2018, the entire content of which is incorporated herein by reference.

### TECHNICAL FIELD

This disclosure generally relates to an imaging system, an imaging device, and a signal processer.

### BACKGROUND DISCUSSION

According to a known technique such as disclosed in JP4820221B, for example, a three-dimensional image including distance information that indicates a distance to a subject (object) and an infrared image of the subject is obtained by means of a single imaging device.

In a case where the distance information and the infrared image which are obtained by means of the single imaging device are output to a signal processor performing various processing based on the aforementioned distance information and infrared image, plural channels are employed.

At this time, when both the distance information and the infrared image are output to the signal processor, an amount of memory, an amount of calculation, and an amount of data transfer necessary for output of the distance information and the infrared image increase as compared to a case where the infrared image is only output to the signal processor. A sufficient system configuration may be thus required.

A need thus exists for an imaging system, an imaging device, and a signal processor which are not susceptible to the drawback mentioned above.

### SUMMARY

According to an aspect of this disclosure, an imaging system includes an imaging device and a signal processer, the imaging device including a cache memory and an imaging controller which acquires an infrared image of a subject and depth information indicating a distance from the imaging device to the subject, the imaging controller transmitting the infrared image to the signal processor and storing the depth information at the cache memory, the signal processer including a signal processing control portion which receives the infrared image from the imaging device, detects a two-dimensional coordinate of a predetermined position on the infrared image transmitted from the imaging device, acquires the depth information for the detected two-dimensional coordinate from the cache memory, generates a three-dimensional coordinate of the predetermined position within a three-dimensional space based on the two-dimensional coordinate and the acquired depth information, and outputs a control signal to an external device based on the three-dimensional coordinate.

According to another aspect of the disclosure, an imaging device includes a cache memory and an imaging controller acquiring an infrared image of a subject and depth information indicating a distance to the subject, transmitting the infrared image to a signal processor, and storing the depth information at the cache memory.

According to still another aspect of the disclosure, a signal processor includes a signal processing control portion receiving an infrared image of a subject from an imaging device which is configured to acquire the infrared image of the subject and depth information indicating a distance to the subject, detecting a two-dimensional coordinate of a predetermined position on the infrared image, acquiring the depth information for the two-dimensional coordinate from a cache memory included in the imaging device, and generating a three-dimensional coordinate of the predetermined position within a three-dimensional space based on the two-dimensional coordinate and the acquired depth information, and outputting a control signal to an external device based on the three-dimensional coordinate.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating a vehicle of which an interior is partially looked through, the vehicle at which an imaging system according to a first embodiment is mounted;

FIG. 2 is a plan view of the vehicle at which the imaging system according to the first embodiment is mounted;

FIG. 3 is a block diagram of functions of the vehicle according to the first embodiment;

FIG. 4 is a block diagram of functions of a vehicle interior camera and an ECU provided at the vehicle according to the first embodiment;

FIG. 5 is a diagram illustrating predetermined positions at each of which a two-dimensional coordinate is detected in a signal processor of the vehicle according to the first embodiment;

FIG. 6 is a diagram explaining a processing for generating three-dimensional coordinates in the signal processor of the vehicle according to the first embodiment;

FIG. 7 is a block diagram of functions of a vehicle interior camera, an imaging device, and an ECU provided at the vehicle according to a second embodiment; and

FIG. 8 is a diagram illustrating an RGB image acquired at the vehicle according to the second embodiment.

### DETAILED DESCRIPTION

Embodiments disclosed here are explained with reference to the attached drawings. Configurations of the embodiments described below, and operations, results, and effects brought about by such configurations are examples. The embodiments are achievable by other configurations than the following configurations and at least one of various effects based on the basic configuration and derived effects may be obtained.

A vehicle at which an imaging system including an imaging device and a signal processor according to the embodiments is mounted may be an automobile including an internal combustion engine (engine) as a driving source (i.e., an internal combustion engine automobile), an automobile including an electric motor (motor) as a driving source (i.e., an electric automobile and a fuel cell automobile, for example), or an automobile including both the engine and the motor as a driving source (i.e., a hybrid automobile), for example. The vehicle may include any types of transmission devices and any types of devices including systems and components, for example, for driving the internal combustion engine or the electric motor. A system, the number, and a layout, for example, of a device related to driving of wheels of the vehicle may be appropriately employed or specified.

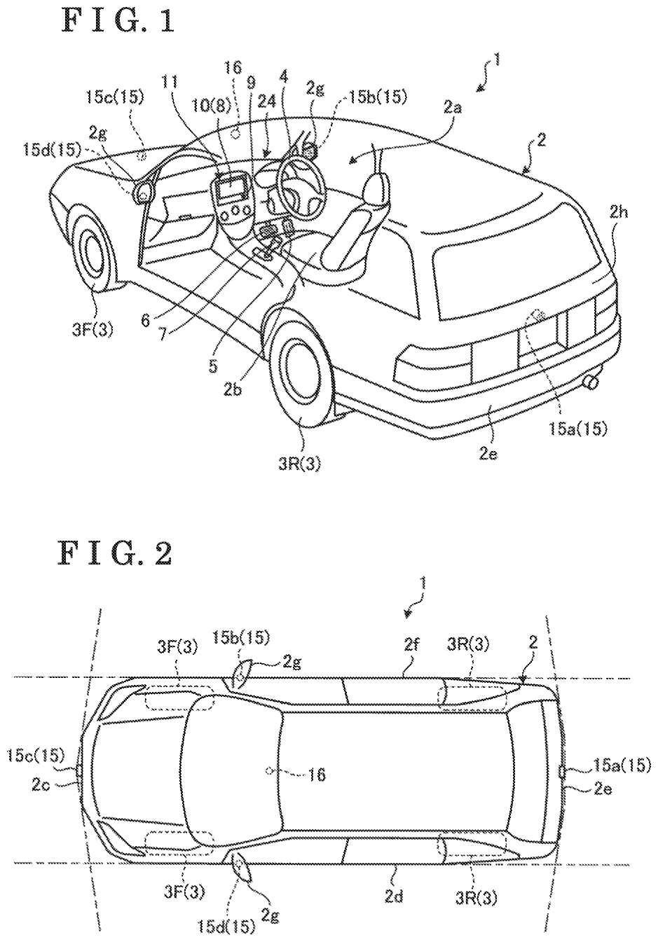

A first embodiment is explained with reference to FIG. 1. As illustrated in FIG. 1, a vehicle 1 at which the imaging system according to the first embodiment is mounted includes a vehicle body 2, a steering portion 4, an accelerating operation portion 5, a braking operation portion 6, a gear change operation portion 7, and a monitor device 11. The vehicle body 2 includes a vehicle interior 2a where a passenger is in. The steering portion 4, the accelerating operation portion 5, the braking operation portion 6, and the gear change operation portion 7, for example, are provided within the vehicle interior 2a so as to be opposed to a seat 2b for a driver serving as a passenger. The steering portion 4 is a steering wheel (a steering handle) protruding from a dashboard 24, for example. The accelerating operation portion 5 is an accelerator pedal provided in the vicinity of the driver's foot, for example. The braking operation portion 6 is a brake pedal provided in the vicinity of the driver's foot, for example. The gear change operation portion 7 is a shift lever protruding from a center console, for example.

The monitor device 11 is provided at a substantially center of the dashboard 24 in a vehicle width direction, i.e., in a right and left direction, thereof. The monitor device 11 may be shared with a navigation system and an audio system, for example. The monitor device 11 includes a display device 8, an audio output device 9, and an operation input portion 10. The monitor device 11 may include any types of operation input portions such as a switch, a dial, a joy stick, and a pressing button, for example.

The display device 8 is a liquid crystal display (LCD) or an organic electroluminescent display (OELD), for example, so as to be configured to display various images based on image data. The audio output device 9, which is constituted by a speaker, for example, outputs various sounds based on audio data. The audio output device 9 is not limited to be provided at the monitor device 11 and may be provided at a different position within the vehicle interior 2a.

The operation input portion 10 is constituted by a touch panel, for example, so as to be configured to input information by a passenger. The operation input portion 10 is provided at a display screen of the display device 8 so that an image displayed at the display device 8 is visible through the operation input portion 10. The passenger may thus visually confirm the image displayed at the display screen of the display device 8 via the operation input portion 10. The operation input portion 10 accepts information by the passenger while detecting the passenger touching the display screen of the display device 8, for example.

As illustrated in FIGS. 1 and 2, the vehicle 1 is a four-wheel automobile, for example, while including right and left front wheels 3F and right and left rear wheels 3R. All of the aforementioned four wheels 3 (3F and 3R) or a part thereof is steerable.

The vehicle 1 is equipped with plural imaging devices 15 (onboard cameras). In the present embodiment, the vehicle 1 includes four imaging devices 15a to 15d, for example. Each of the imaging devices 15 is a digital camera incorporating an imaging element such as a charge coupled device (CCD) and a CMOS image sensor (CIS), for example. The imaging device 15 may capture an image of surroundings of the vehicle 1 at a predetermined frame rate. The imaging device 15 outputs a captured image obtained by capturing the image of the surroundings of the vehicle 1. The imaging device 15 has a wide-angle lens or a fisheye lens and may photograph a range of, for example, 140° to 220° in a horizontal direction. An optical axis of the imaging device 15 may be possibly set obliquely downward.

Specifically, the imaging device 15a is positioned at a rear end portion 2e of the vehicle body 2 and is provided at a wall portion below a rear window of a door 2h of a rear hatch, for example. The imaging device 15a may capture an image of a rear region of the vehicle 1 among the surroundings of the vehicle 1. The imaging device 15b is positioned at a right side of the vehicle body 2, i.e., at a right-end portion 2f in the vehicle width direction and is provided at a right-side door mirror 2g, for example. The imaging device 15b may capture an image of a lateral region of the vehicle 1 among the surroundings of the vehicle 1. The imaging device 15c is positioned at a front side of the vehicle body 2, i.e., at a front end portion 2c of the vehicle 1 in a front-rear direction and is provided at a front bumper or a front grill, for example. The imaging device 15c may capture an image of a front region of the vehicle 1 among the surroundings of the vehicle 1. The imaging device 15d is positioned at a left side of the vehicle body 2, i.e., at a left-end portion 2d in the vehicle width direction and is provided at a left-side door mirror 2g, for example. The imaging device 15d may capture an image of a lateral region of the vehicle 1 among the surroundings of the vehicle 1.

As illustrated in FIGS. 1 and 2, a vehicle interior camera 16 serving as an imaging device is provided at the vehicle interior 2a. The vehicle interior camera 16 is configured to acquire an infrared image of a subject (i.e., an object that exists at the vehicle interior 2a, such as a passenger and the seat 2b within the vehicle interior 2a, for example) and depth information indicating a distance from the vehicle interior camera 16 to the subject. In the present embodiment, the vehicle interior camera 16 is a time of flight (TOF) camera serving as the imaging device for acquiring the infrared image of the subject and the depth information.

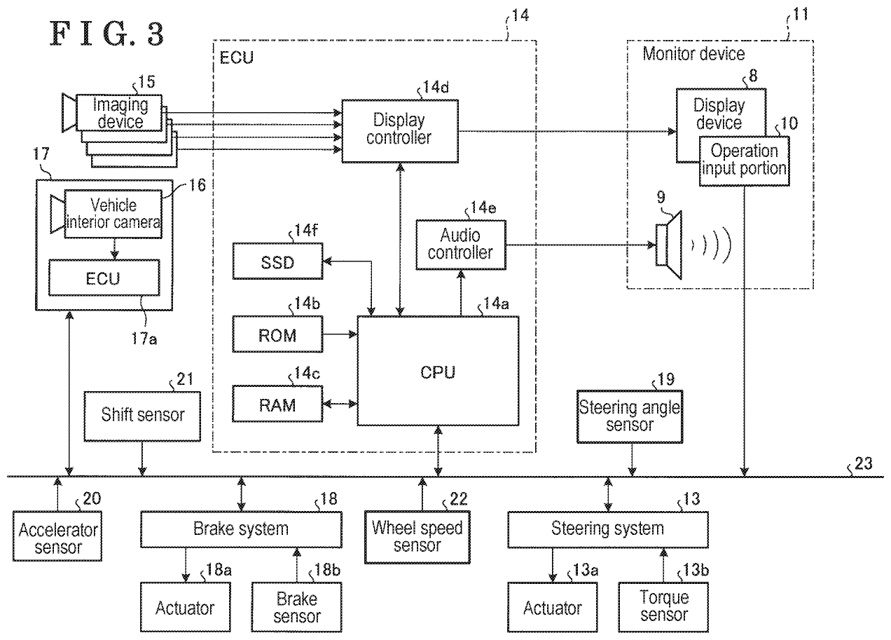

As illustrated in FIG. 3, the vehicle 1 includes a steering system 13, a brake system 18, a steering angle sensor 19, an accelerator sensor 20, a shift sensor 21, a wheel speed sensor 22, an in-vehicle network 23, an electronic control unit (ECU) 14, the imaging devices 15, and an imaging system 17. The monitor device 11, the steering system 13, the imaging system 17, the brake system 18, the steering angle sensor 19, the accelerator sensor 20, the shift sensor 21, the wheel speed sensor 22, and the ECU 14 are electrically connected to one another via the in-vehicle network 23. The in-vehicle network 23 is configured as a controller area network (CAN), for example.

The steering system 13 is an electric power steering system or a steer by wire (SBVV) system, for example. The steering system 13 includes an actuator 13a and a torque sensor 13b. The steering system 13 that is electrically controlled by the ECU 14, for example, operates the actuator 13a to apply a torque to the steering portion 4 for supplementing a steering force, thereby steering the wheel(s) 3. The torque sensor 13b detects a torque applied to the steering portion 4 by the driver and transmits a detection result to the ECU 14.

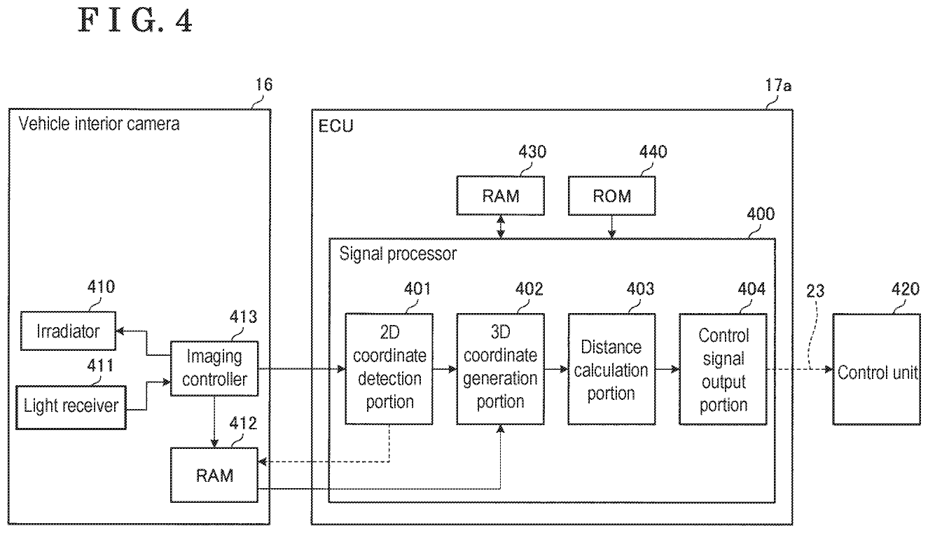

The imaging system 17 includes the vehicle interior camera 16 and an ECU 17a. The ECU 17a controls an external device such as a control unit 420 (see FIG. 4), for example, included in the vehicle 1 based on the infrared image of the subject and the depth information obtained by means of the vehicle interior camera 16.

The brake system 18 includes an anti-lock brake system (ABS) restraining the wheels of the vehicle 1 from locking during braking, an electronic stability control (ESC) restraining skidding of the vehicle 1 upon cornering thereof, an electric (power) brake system performing a braking assist by enhancing a braking force, and a brake by wire (BBW). The brake system 18 includes an actuator 18a and a brake sensor 18b, for example. The brake system 18 is electrically controlled by the ECU 14, for example, so as to apply a braking force to each of the wheels 3 via the actuator 18a. The brake system 18 may perform a control for restraining the wheels of the vehicle 1 from locking during braking, free spin of the wheels 3, and skidding by detecting a sign of locking of the wheels, free spin of the wheels 3, and skidding of the vehicle 1 based on difference in rotations between the right and left wheels 3, for example. The brake sensor 18b is a displacement sensor detecting a position of the brake pedal serving as a movable part of the braking operation portion 6. The brake sensor 18b transmits a detection result of the position of the brake pedal to the ECU 14.

The steering angle sensor 19 detects a steering amount of the steering portion 4 such as a steering wheel, for example. In the embodiment, the steering angle sensor 19, which is configured with a Hall element, for example, detects a rotation angle of a rotary part of the steering portion 4 as a steering amount and transmits a detection result to the ECU 14. The accelerator sensor 20 is a displacement sensor detecting a position of the accelerator pedal serving as a movable part of the accelerating operation portion 5. The accelerator sensor 20 transmits a detection result to the ECU 14.

The shift sensor 21 detects a position of a movable part of the gear change operation portion 7 (for example, a bar, an arm, and a button) and transmits a detection result to the ECU 14. The wheel speed sensor 22 including a Hall element, for example, detects an amount of rotations of the wheel 3 and the number of rotations (a rotation speed) thereof per time unit and transmits a detection result to the ECU 14.

The ECU 14 entirely controls the vehicle 1 by being constituted by computer, for example, where hardware and software operate in cooperation with each other. Specifically, the ECU 14 includes a central processing unit (CPU) 14a, a read only memory (ROM) 14b, a random access memory (RAM) 14c, a display controller 14d, an audio controller 14e, and a solid state drive (SSD) 14f. The CPU 14a, the ROM 14b, and the RAM 14c may be provided within a single circuit board.

The CPU 14a reads out program stored at a non-volatile storage unit such as the ROM 14b, for example, and performs an arithmetic processing based on such program. For example, the CPU 14a performs an image processing on image data displayed at the display device 8, and a driving control processing of the vehicle 1 along a target path to a target position such as a parking position, for example.

The ROM 14b stores various programs and parameters for executing such programs. The RAM 14c tentatively stores various data used for calculation at the CPU 14a. The display controller 14d mainly performs an image processing on image data acquired from the imaging devices 15 so that the resulting image data is output to the CPU 14a, and a conversion of the image data acquired from the CPU 14a to image data for display at the display device 8, among the arithmetic processing performed at the ECU 14. The audio controller 14e mainly performs a processing of sound acquired from the CPU 14a so that the audio output device 9 outputs the resulting sound, among the arithmetic processing performed at the ECU 14. The SSD 14f that is a rewritable non-volatile storage unit is configured to store data obtained from the CPU 14a even when a power source of the ECU 14 is turned off.

A functional structure of the vehicle interior camera 16 included in the imaging system 17 is explained with reference to FIG. 4.

As illustrated in FIG. 4, the vehicle interior camera 16 includes an irradiator 410, a light receiver 411, a RAM 412, and an imaging controller 413. The RAM 412 is a cache memory where information such as depth information is storable.

The irradiator 410 is controlled by the imaging controller 413. The irradiator 410 is configured to irradiate infrared rays to a subject (object) within the vehicle interior 2a such as a passenger, for example. The light receiver 411 is also controlled by the imaging controller 413. The light receiver 411 is configured to receive a reflected light of the infrared rays from the subject, the infrared rays being irradiated from the irradiator 410.

The imaging controller 413 acquires (generates) the infrared image of the subject and the depth information which are obtained by capturing an image of the subject. In the present embodiment, the imaging controller 413 acquires the infrared image (IR image) of the subject and the depth information indicating a distance from the vehicle interior camera 16 to the subject based on the reflected light from the subject received by the light receiver 411 by controlling the irradiator 410 and the light receiver 411. In the present embodiment, the imaging controller 413 acquires the infrared image with a predetermined resolution (for example, 640×480) at a predetermined frame rate and the depth information.

The imaging controller 413 transmits the acquired infrared image to a signal processor 400. In the embodiment, the imaging controller 413 transmits the acquired infrared image to the signal processor 400 each time the infrared image is acquired at the predetermined frame rate.

The imaging controller 413 stores the acquired depth information at the RAM 412. The depth information acquired by the vehicle interior camera 16 capturing the image of the subject is thus inhibited from being fully transmitted to the signal processor 400. An amount of memory for storing data (such as the infrared image and the depth information) transmitted from the vehicle interior camera 16, an amount of calculation related to signal processing on data received by the signal processor 400, and an amount of data transfer between the vehicle interior camera 16 and the signal processor 400 may be reduced at the signal processor 400.

Because the amount of calculation related to data output to the signal processor 400 is reduced, power consumption at the vehicle interior camera 16 is reduced. In addition, because the amount of data transfer to the signal processor 400 is reduced, the infrared image with higher resolution is transmittable to the signal processor 400. Further, because the amount of calculation related to data output to the signal processor 400 is reduced so that a calculation unit such as the CPU, for example, included in the vehicle interior camera 16 may have a lower specification, the vehicle interior camera 16 at a reduced cost and with a reduced size is achievable.

In the present embodiment, each time the control of the external device (the control unit 420) using the infrared image is completed at the signal processor 400, the imaging controller 413 deletes the depth information acquired in synchronization with the aforementioned infrared image from the RAM 412 among the depth information stored at the RAM 412.

Next, a functional structure of the ECU 17a included in the imaging system 17 is explained.

As illustrated in FIG. 4, the ECU 17a includes the signal processor 400, a RAM 430, and a ROM 440. The ROM 440 stores various programs and parameters for executing such programs. The RAM 430 tentatively stores various data used for calculation at the signal processor 400. In the present embodiment, the signal processor 400 including a processor such as a CPU mounted at a circuit board, for example, executes a control program stored in a storage medium such as the ROM 440, for example, to realize functions of a two-dimensional (2D) coordinate detection portion 401, a three-dimensional (3D) coordinate generation portion 402, a distance calculation portion 403, and a control signal output portion 404. The signal processor 400 may be partially or fully constituted by hardware such as a circuit, for example. In the present embodiment, the 2D coordinate detection portion 401, the 3D coordinate generation portion 402, the distance calculation portion 403, and the control signal output portion 404 function as a signal processing control portion.

The 2D coordinate detection portion 401 receives the infrared image from the vehicle interior camera 16. The 2D coordinate detection portion 401 detects coordinates of predetermined positions in the received infrared image (which are hereinafter called 2D coordinates). The aforementioned predetermined positions are positions specified beforehand in the infrared image.

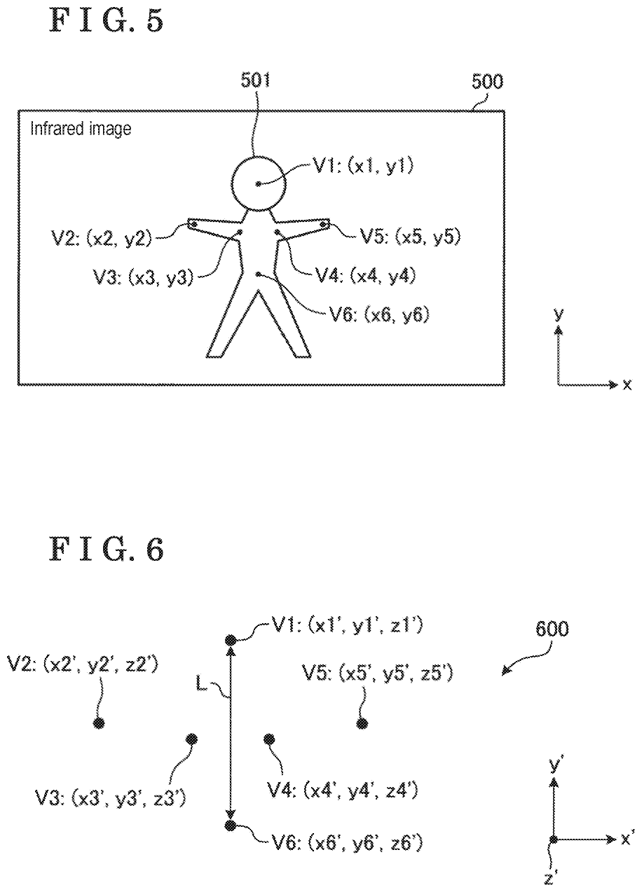

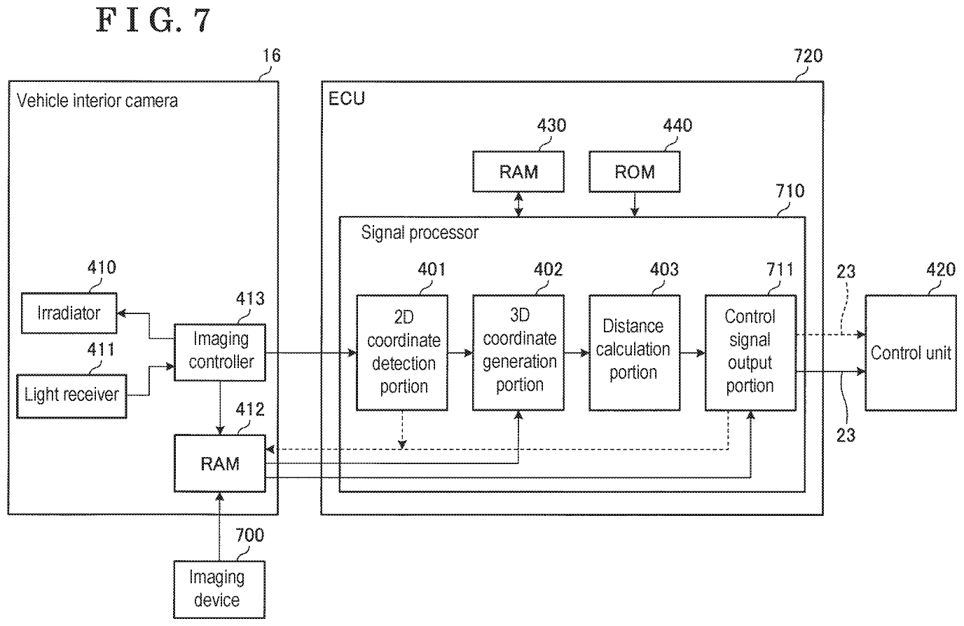

FIG. 5 is a diagram illustrating the predetermined positions at which the 2D coordinates are detected in the signal processor 400 according to the present embodiment. In an infrared image 500 illustrated in FIG. 5, a lateral direction corresponding to a width direction of the vehicle 1 (vehicle width direction) is defined as an x-axis and a vertical direction corresponding to a height direction of the vehicle 1 (vehicle height direction) is defined as a y-axis.

In a case where an angle at which an air bag of the vehicle 1 is deployed and strength upon deployment of the air bag are controlled, or a seat position serving as a position of the seat 2b is detected using the infrared image 500 and the depth information obtained by the imaging performed by the vehicle interior camera 16, for example, the 2D coordinate detection portion 401 detects a head portion V1, a right hand V2, a right shoulder V3, a left shoulder V4, a left hand V5, and a waist (a portion around a waist) V6 of a human image 501 included in the infrared image 500 as the predetermined positions.

As illustrated in FIG. 5, the 2D coordinate detection portion 401 detects 2D coordinates V1: (x1, y1), V2: (x2, y2), V3: (x3, y3), V4: (x4, y4), V5: (x5, y5), and V6: (x6, y6) serving as the respective 2D coordinates of the head portion V1, the right hand V2, the right shoulder V3, the left shoulder V4, the left hand V5, and the waist V6 of the human image 501 included in the infrared image 500.

As illustrated in FIG. 4, the 3D coordinate generation portion 402 acquires the depth information for the 2D coordinates extracted by the 2D coordinate detection portion 401 from the RAM 412 of the vehicle interior camera 16. That is, the depth information acquired by the vehicle interior camera 16 is inhibited from being entirely transmitted to the signal processor 400. An amount of memory for storing data (such as the infrared image and the depth information) transmitted from the vehicle interior camera 16, an amount of calculation related to signal processing on data received by the signal processor 400, and an amount of data transfer between the vehicle interior camera 16 and the signal processor 400 may be reduced at the signal processor 400.

Because the amount of calculation related to data input from the vehicle interior camera 16 is reduced, power consumption at the signal processor 400 is reduced. In addition, because the amount of data transfer to the signal processor 400 is reduced, the infrared image with higher resolution is acquirable. Further, because the amount of calculation related to data input from the vehicle interior camera 16 is reduced so that a calculation unit such as the CPU 14a, for example, included in the signal processor 400 may have a lower specification, the signal processor 400 at a reduced cost and with a reduced size is achievable.

The aforementioned depth information for the 2D coordinates serves as the depth information indicating a distance from the vehicle interior camera 16 to each position corresponding to the predetermined position at the subject among the depth information obtained from the vehicle interior camera 16 in synchronization with the infrared image where the 2D coordinates are extracted.

The 3D coordinate generation portion 402 generates a coordinate of a predetermined position within a three-dimensional (3D) space (a real space) based on the 2D coordinate extracted from the 2D coordinate detection portion 401 and the depth information acquired from the RAM 412 (i.e., the 3D coordinate generation portion 402 generates a three-dimensional coordinate). In the present embodiment, the 3D coordinate generation portion 402 generates the three-dimensional (3D) coordinate of the predetermined position at the three-dimensional (3D) space based on the 2D coordinate and the depth information.

A processing for generating the 3D coordinate in the signal processor 400 of the vehicle 1 according to the present embodiment is explained with reference to FIG. 6. A 3D space 600 illustrated in FIG. 6 is defined by an x′-axis corresponding to the vehicle width direction, a y′-axis corresponding to the vehicle height direction, and a z′-axis corresponding to a travelling direction of the vehicle 1.

In a case where the respective 2D coordinates of the head portion V1, the right hand V2, the right shoulder V3, the left shoulder V4, the left hand V5, and the waist V6 are detected from the human image 501 included in the infrared image 500 illustrated in FIG. 5, the 3D coordinate generation portion 402 generates respective 3D coordinates V1: (x1′, y1′, z1′), V2: (x2′, y2′, z2′), V3: (x3′, y3′, z3′), V4: (x4′, y4′, z4′), V5: (x5′, y5′, z5′), and V6: (x6′, y6′, z6′) serving as 3D coordinates of the head portion V1, the right hand V2, the right shoulder V3, the left shoulder V4, the left hand V5, and the waist V6 of the human image 501 at the 3D space 600 based on the 2D coordinates and the corresponding depth information.

In the present embodiment, a two-dimensional image device from which the signal processor 400 receives or acquires the infrared image and the depth information is the vehicle interior camera 16. Instead of the vehicle interior camera 16, any imaging device is available as long as the infrared image and the depth information are acquirable and such imaging device includes a similar construction to the vehicle interior camera 16. For example, the two-dimensional image device from which the signal processor 400 receives or acquires the infrared image and the depth information may be the imaging device 15 configured to capture an image of surroundings of the vehicle 1.

As illustrated in FIG. 4, the distance calculation portion 403 calculates a distance between predetermined positions in the 3D space (i.e., a distance between the 3D coordinates) based on the respective 3D coordinates of the plural predetermined positions generated by the 3D coordinate generation portion 402. For example, in a case of detecting an angle at which an air bag of the vehicle 1 is deployed, strength upon deployment of the air bag, a seat position serving as the position of the seat 2b, or the skeleton (framework) of the passenger seated on the seat 2b, for example, the distance calculation portion 403 calculates a distance L between the head portion V1: (x1′, y1′, z1′) and the waist V6: (x6′, y6′, z6′) in the human image within the 3D space 600 as illustrated in FIG. 6.

In the present embodiment, the signal processor 400 includes the distance calculation portion 403. As long as the control signal output portion 404 is configured to output a control signal to the external device based on the 3D coordinates generated by the 3D coordinate generation portion 402, the distance calculation portion 403 may be omitted.

The control signal output portion 404 outputs a control signal to the external device such as the control unit 420 via the in-vehicle network 23 based on a distance between the 3D coordinates calculated by the distance calculation portion 403. In the present embodiment, the control signal output portion 404 outputs the control signal to the external device based on the distance calculated by the distance calculation portion 403. Alternatively, the control signal output portion 404 may output the control signal to the external device via the in-vehicle network 23 based on the 3D coordinates generated by the 3D coordinate generation portion 402.

In a case where a control unit of an air bag (supplemental restraint system (SRS) air bag system) included in the vehicle 1 serves as the control unit 420, for example, the control signal output portion 404 outputs the control signal for controlling a direction in which the air bag is deployed or a pressure within the air bag upon deployment thereof based on the distance between each of the 3D coordinates and the SRS air bag system serving as the control unit 420.

In a case where a control unit for controlling the position of the seat 2b serves as the control unit 420, for example, the control signal output portion 404 outputs the control signal for moving the seat 2b to the seat position suitable for the passenger with the skeleton (framework) corresponding to the calculated distance between the 3D coordinates.

The control unit 420 performs various functions (for example, an air bag control function and an automatic seat position adjustment function) included in the vehicle 1 based on the control signal transmitted from the control signal output portion 404.

According to the first embodiment, the depth information obtained by the imaging performed by the vehicle interior camera 16 is inhibited from being entirely transmitted to the signal processor 400. Thus, an amount of memory for storing data (such as the infrared image and the depth information) transmitted from the vehicle interior camera 16, an amount of calculation related to signal processing on data received by the signal processor 400, and an amount of data transfer between the vehicle interior camera 16 and the signal processor 400 may be reduced at the signal processor 400.

According to a second embodiment, the RAM included in the vehicle interior camera stores an RGB image obtained through capturing an image of a subject (object) by an imaging device provided outside the imaging system. The signal processor then acquires the RGB image from the RAM, and outputs the control signal including the 3D coordinates and the acquired RGB image to the external device. In the following, an explanation for the same or substantially the same components as the first embodiment is omitted.

According to the second embodiment, the vehicle 1 includes an imaging device 700 (an external imaging device) which is different from the vehicle interior camera 16 and is provided outside the imaging system 17 so as to capture an image of a passenger in the vehicle 1.

The imaging device 700 is a digital camera including an imaging element such as a charge coupled device (CCD) and a CMOS image sensor (CIS), for example. The RGB image (RGB images) obtained by the imaging device 700 that captures an image within the vehicle interior 2a is stored at the RAM 412 of the vehicle interior camera 16. In the present embodiment, the imaging device 700 captures an image inside the vehicle interior 2a in synchronization with the imaging performed by the vehicle interior camera 16.

In the second embodiment, the RGB image obtained by capturing an image of the inside of the vehicle interior 2a by the imaging device 700 is stored at the RAM 412. Alternatively, a captured image (RGB image) output from the imaging device 15 that captures an image outside the vehicle 1 or vehicle information related to the vehicle 1 (for example, a steering amount detected by the steering angle sensor 19, and the number of rotations (rotation speed) of the wheel 3 detected by the wheel speed sensor 22) may be stored at the RAM 412.

In the second embodiment, an ECU 720 corresponding to the ECU 17a of the first embodiment includes a signal processor 710 that includes a control signal output portion 711 acquiring the RGB image from the RAM 412. At this time, the control signal output portion 711 is configured to acquire the RGB image that is output from the RAM 412 in synchronization with the infrared image where the 2D coordinates are detected by the 2D coordinate detection portion 401. The control signal output portion 711 outputs the control signal including the acquired RGB image to the control unit 420.

Accordingly, in a case where the captured image obtained by the imaging device 700 that is separately provided from the vehicle interior camera 16 is output to the control unit 420 as the control signal, it is inhibited that all captured images acquired by the imaging device 700 are transmitted to the signal processor 710. An amount of memory for storing data transmitted from the imaging device 700, an amount of calculation related to signal processing on data received by the signal processor 710, and an amount of data transfer between the imaging device 700 and the signal processor 710 may be reduced at the signal processor 710.

In the second embodiment, the control signal output portion 711 is configured to output the control signal including the acquired RGB image and the 3D coordinates to the control unit 420 in a case where the control unit 420 includes a function to display the RGB image at the display device 8. At this time, the control signal output portion 711 superimposes position information with which the predetermined position is identifiable on the RGB image and outputs the control signal including the RGB image on which the position information is superimposed to the control unit 420. Accordingly, which position on the passenger's body is employed for executing the function by the control unit 420 may be confirmed on a basis of the RGB image displayed at the display device 8.

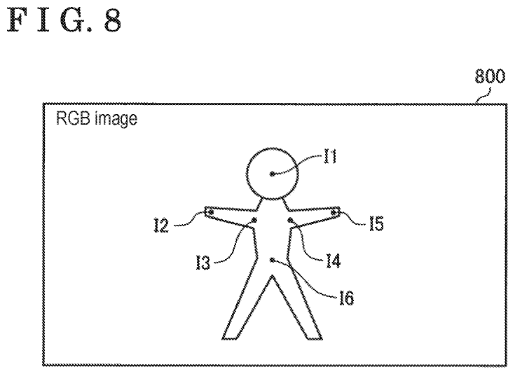

In a case where the control unit 420 is an SRS air bag system, or the control unit 420 includes a function for automatically adjusting the position of the seat 2b, the control signal output portion 711 outputs the control signal including an RGB image 800 on which position information I1 to 16 indicating respective positions of the head portion V1, the right hand V2, the right shoulder V3, the left shoulder V4, the left hand V5, and the waist V6 serving as the predetermined positions is superimposed, as illustrated in FIG. 8, to the control unit 420.

The control unit 420 then displays the RGB image 800 included in the control signal sent from the control signal output portion 711 at the display device 8 via the display controller 14d. Based on the RGB image displayed at the display device 8, it is confirmable that which position on the passenger's body is used for executing the SRS air bag system and the automatic seat position function.

According to the second embodiment, in a case where the captured image obtained by the imaging device 700 that is separately provided from the vehicle interior camera 16 is output to the control unit 420 as the control signal, all the captured images obtained by the imaging device 700 are inhibited from being transmitted to the signal processor 710. As a result, an amount of memory for storing data transmitted from the imaging device 700, an amount of calculation related to signal processing on data received by the signal processor 710, and an amount of data transfer between the imaging device 700 and the signal processor 710 may be reduced at the signal processor 710.

According to the aforementioned second embodiment, the imaging system 17 includes the irradiator 410 irradiating infrared rays to the subject, and the light receiver 411 receiving a reflected light of the infrared rays from the subject. The imaging controller 413 acquires the infrared image of the subject based on the reflected light. The RAM (cache memory) 412 stores an RGB image obtained by capturing an image of the subject by the external imaging device 700. The signal processing control portion 401-404 acquires the RGB image from the RAM 412 and outputs the control signal including the acquired RGB image to the control unit 420.

In addition, according to the second embodiment, the imaging device 16 includes the irradiator 410 irradiating infrared rays to the subject, and the light receiver 411 receiving a reflected light of the infrared rays from the subject. The imaging controller 413 acquires the infrared image of the subject based on the reflected light. The RAM 412 stores an RGB image obtained by capturing an image of the subject by the external imaging device 700.

Further, according to the second embodiment, the signal processor 710, the signal processing control portion 401-404 acquires an RGB image from the RAM 412, the RGB image being obtained by capturing an image of the subject by the external imaging device 700 that is separately provided from the imaging device 16, and outputs the control signal including the acquired RGB image to the control unit 420.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An imaging system comprising:
an imaging device; and
a signal processer,
the imaging device including a cache memory and an imaging controller which acquires an infrared image of a subject and depth information indicating a distance from the imaging device to the subject, the imaging controller transmitting the infrared image to the signal processor and storing the depth information at the cache memory;
the signal processer including a signal processing control portion which receives the infrared image from the imaging device, detects a two-dimensional coordinate of a predetermined position on the infrared image transmitted from the imaging device, acquires the depth information for the detected two-dimensional coordinate from the cache memory, generates a three-dimensional coordinate of the predetermined position within a three-dimensional space based on the two-dimensional coordinate and the acquired depth information, and outputs a control signal to an external device based on the three-dimensional coordinate.

2. The imaging system according to claim 1, wherein the imaging device includes:
an irradiator irradiating infrared rays to the subject; and
a light receiver receiving a reflected light of the infrared rays from the subject, wherein
the imaging controller acquires the infrared image of the subject based on the reflected light,
the cache memory stores an RGB image obtained by capturing an image of the subject by an external imaging device,
the signal processing control portion acquires the RGB image from the cache memory and outputs the control signal including the acquired RGB image to the external device.

3. An imaging device comprising:
a cache memory; and
an imaging controller acquiring an infrared image of a subject and depth information indicating a distance to the subject, transmitting the infrared image to a signal processor, and storing the depth information at the cache memory.

4. The imaging device according to claim 3, further comprising:
an irradiator irradiating infrared rays to the subject; and
a light receiver receiving a reflected light of the infrared rays from the subject, wherein
the imaging controller acquires the infrared image of the subject based on the reflected light,
the cache memory stores an RGB image obtained by capturing an image of the subject by an external imaging device.

5. A signal processor comprising:
a signal processing control portion receiving an infrared image of a subject from an imaging device which is configured to acquire the infrared image of the subject and depth information indicating a distance to the subject, detecting a two-dimensional coordinate of a predetermined position on the infrared image, acquiring the depth information for the two-dimensional coordinate from a cache memory included in the imaging device, and generating a three-dimensional coordinate of the predetermined position within a three-dimensional space based on the two-dimensional coordinate and the acquired depth information, and outputting a control signal to an external device based on the three-dimensional coordinate.

6. The signal processor according to claim 5, wherein the signal processing control portion acquires an RGB image from the cache memory, the RGB image being obtained by capturing an image of the subject by an external imaging device that is separately provided from the imaging device, and outputs the control signal including the acquired RGB image to the external device.
